(19) United States
(12) Patent Application Publication
(10) Pub. No.: US 2003/0024638 A1
(43) Pub. Date: Feb. 6, 2003

(54) Adhesively bonded water conductor assembly

(76) Inventor: Bart R. Jones, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/922,030

(22) Filed: Aug. 3, 2001

(51) Int. Cl. C09J 1/00

(52) U.S. Cl. 156/330

(57) ABSTRACT

A water conductor assembly (10), including a hose (12) having a first mating surface (14) and a outlet (16) having a second mating surface (18). The outlet (16) is adhesively bonded to the hose (12) with an adhesive (22).

### TECHNICAL FIELD

The present invention relates to adhesively bonded engine component assemblies and more particularly to adhesively bonded water conductor assemblies. The invention also relates to water conductor assemblies employing a cure-on-demand adhesive.

### BACKGROUND OF THE INVENTION

Historically, fabrication techniques for the manufacture of automotive engine water conductors and water conductor assemblies have involved the fabrication of separate metal, plastic and rubber components (e.g., cast block, a rubber hose and an intermediate fixture) and the joinder of the components using expensive fastening mechanisms located substantially about the peripheries of one or more of the components. The fastening mechanisms typically include metal band clamps or other fasteners. Fabrication of water conductor assemblies in this manner has tended to be labor intensive and can be costly due to the parts, time and labor required for assembly.

Moreover, joinder of water conductor assemblies can cause additional problems. For example, joinder problems such as poor sealing of various adjoining components (e.g., thermoplastic, rubber and metal components) may be experienced due to various levels of creep, corrosion, warpage, or other deterioration caused by the various liquids and/or temperature ranges to which the components are exposed.

Accordingly, there is a need to provide a method of manufacture and resulting assembly, pursuant to which multiple components of a water conductor assembly are joined together with one or more adhesive bonds. There is a further need for respective components to be attached to each other reliably and inexpensively in the optional absence of clamping bands, fasteners, gaskets or a combination thereof. There is still a further need for a high integrity joint to be achieved by opposing mating surfaces that are non planar, thereby enabling intricate plastic component shapes (with or without additional integrated components) to be made by conventional molding processes.

### SUMMARY OF THE INVENTION

The present invention meets the above needs and others by providing an automotive engine water conductor assembly including at least one outlet having a first mating surface, and a hose having a second mating surface. A layer of adhesive is provided between the outlet and the hose in contact with the respective mating surfaces for joining the outlet to the hose to define a water conductor assembly. Additionally, the outlet may have a third mating surface adhesively bonded to a fourth mating surface of another structure (e.g., an engine block) with a layer of adhesive.

### BRIEF DESCRIPTION OF THE DRAWINGS

FIG. 1 is an exploded perspective view of a partially cut away water conductor assembly in accordance with the present invention.

FIG. 2 is a partially exploded sectional view of the water conductor assembly of FIG. 1.

FIG. 3 is an enlarged sectional view of a portion of the water conductor assembly of FIG. 1 assembled together with adhesive joints.

### DETAILED DESCRIPTION OF THE PREFERRED EMBODIMENT

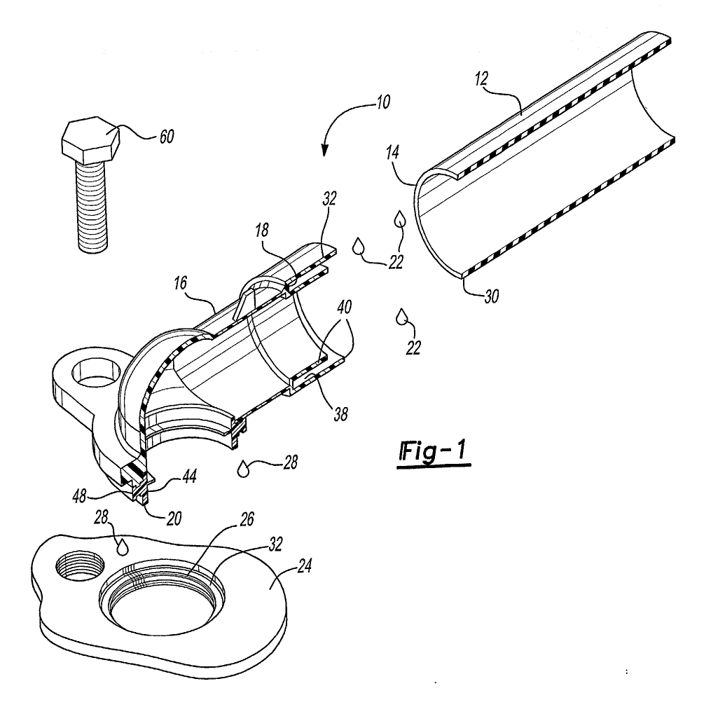

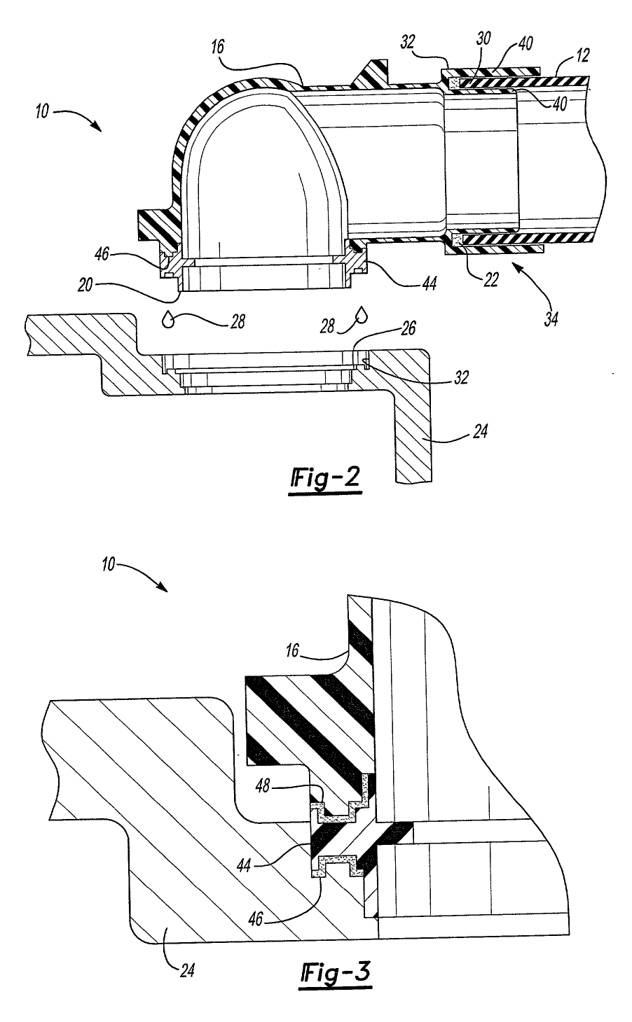

Referring to FIGS. 1-3 there is shown a water conductor assembly 10 of the present invention including a hose 12 having a first mating surface 14. The assembly 10 also includes a generally annular attachment arm defining an outlet 16 (or inlet) having a second mating surface 18 and a third mating surface 20. The hose 12 is bonded to the outlet 16 with a first intermediate layer of adhesive 22. In a particularly preferred embodiment, a component 24 (e.g., an engine block or the like) having a fourth mating surface 26 is bonded with a second intermediate layer of adhesive 28 to the outlet 16. Any or all of the first, second, third or fourth mating surfaces can include one or more additional coatings, layers or components. Thus, it is contemplated that the mating surfaces of any of the components may not necessarily be integrally formed on the components.

Optionally, any or all of the hose 12, the outlet 16 and the component 24 has a structure for facilitating joinder or location of the components relative to each other. Typically, a first mating structure 30 (e.g., an end of the hose 12 of outlet 16) associated with one component will engage a second mating structure 32 (e.g., an end portion of the outlet 16 or circumferential portion of the block 24). In like manner, the first and second mating structures 30 and 32 can be interchanged between the hose 12, the outlet 16 and the component 24. Such engagement can be about the periphery of a component, on an interior portion (not shown) or both.

In one embodiment, shown in FIGS. 1-3, a mechanical and adhesive joint 34 is employed and results from an end 30 of the hose 12 being matingly fitted into a channel 38 formed on the outlet 16 that is at least partially defined by a pair of opposing spaced concentric walls 40 (which may be optionally circumferential) of the outlet 16, wherein adhesive 22 is placed in the channel 38. Also in the embodiment of FIGS. 1-3, an annular gasket 44 of the outlet 16 is joined with an adhesive joint 46 to the cast block 24 by applying adhesive at the mating surfaces 20, 26 on the block 24 and the outlet 16. As shown, the gasket 44 may be attached as part of the outlet 16 with another adhesive joint 48. In another embodiment, the gasket 44 is omitted. Optionally one or more fasteners 60 may be used to assist in joining the outlet 16 to the component 24.

As indicated the above structural features could be interchanged as between the outlet, component and hose. Other joints are also contemplated as possible within a single assembly. As desired, any suitable coating structure may be employed. For instance, a friction fit, an interference fit or some other interlock fit may be used to join the hose with the outlet. Examples of suitable joints include butt joints, lap joints, tongue in groove joint or the like. Further examples are illustrated in commonly owned, co-pending U.S. application Ser. No. 09/826,477 (filed Apr. 4, 2001; entitled “Adhesively Bonded Engine Intake Manifold Assembly”) and U.S. application Ser. No. 09/825,721 (filed Apr. 4, 2001; entitled “Adhesively Bonded Radiator Assembly”). Other suitable structures or surface treatments may be employed for providing an increase in the amount of surface area of the mating surfaces of the joint, or the overlap between the respect mating surfaces of the components. As a further option, a tang or other like structure may be formed in the hose, the outlet or both for assisting in achieving a snap fit or for providing an audible locator for facilitating assembly. It should also be appreciated that the above structures may be suitably interchanged between components. For example, the opposing walls may be formed in the hose 12 and complementary mating structure formed on the outlet 16.

The adhesive preferably is provided over at least a portion of the surfaces to be joined, and preferably sufficiently about the periphery so that there are no appreciable gaps that result between joined components. In one embodiment, a bead of adhesive is placed (e.g., by pumping) on the respective mating surface of at least one of the components and the opposing mating surface is brought into contact with it. The assembly is then cured. In another embodiment, the adhesive is precoated (e.g., by spraying, dipping, brushing, swabbing, or the like) on one or both of the mating surfaces of the respective components and then the components are joined and cured. Any other suitable joining technique may likewise be employed. Preferably the amount of adhesive employed is sufficient to achieve the desired performance characteristics of the assembly. Such amount will vary from application to application.

In one embodiment the invention encompasses having disposed on the mating surfaces of the respective components a continuous bead or film of adhesive. As used herein continuous bead or film of adhesive means a bead or film of adhesive that is disposed around the periphery of the mating surface and the end of the adhesive bead or film connects with the beginning of the adhesive bead or film. The continuous bead or film of adhesive upon cure is capable all of forming an air and liquid tight seal between the components. This function allows the adhesive bead or film to replace gaskets as the sealing means. The adhesive may be applied to the conductor components in the immediate vicinity of the location where the components are to be contacted with each other or it may be applied in a location remote from where or when the components are to be contacted. Remote as used herein refers can refer to one or both of time and location. In the embodiment where the adhesive is applied to one or more of the components remote from the place wherein the components are joined together a cure-on-demand adhesive is used.

In a preferred embodiment of the present invention, the end tanks, heat exchanger or each of them is fabricated from a plastic material, i.e., a thermoset material, a thermoplastic material, or a mixture thereof. Among preferred high-performance thermoplastic materials are polybutylene terephthalate, polyetherimides, polyphenylene ether/polyamide resins, polyether sulfone resins, polyether ether ketone resins, liquid crystal polymers, polyarylsulfone resins, polyamideimide resins, polyphthalimide resins, nylon 6, 6, polyamide resins, syndiotactic polystyrene, and blends thereof. In a particular preferred embodiment, the material is a thermoplastic selected from polyamides, polystyrenes, polyolefins, polycarbonates, or mixtures thereof. More preferably, the material is selected from polyamides (e.g., nylon 6,6), polystyrenes or mixtures thereof. In one preferred embodiment, the material is a blend of polyamides and syndiotactic polystyrenes, and more preferably a blend of nylon 6,6 and syndiotactic polystyrene. Among useful thermoset materials are epoxy resins.

The plastics used for preparing the components typically will also include other ingredients, such as reinforcements, property modifiers (e.g., impact modifiers, flame retardants, UV protectants or the like) or other suitable fillers (e.g., chopped glass, mineral, talc, calcium carbonate, or the like). For instance, in one embodiment, the plastic is glass filled in an amount of about 10 to about 50 volume percent and more preferably about 35 volume percent. Preferably, the material selected exhibits a tensile strength of at least about 175 MPa and more preferably at least about 225 MPa, and an elongation of about 1 to about 10%, and more preferably about 3 to about 5%. The material is also thermal resistant and will withstand without degradation temperatures of at least about 135° C. (about 275° F.) and more preferably 177° C. (350° F.) for at least about 144 hours and more preferably 168 hours.

Of course, one or more of the components might be a metal (e.g., cast iron, steel, magnesium, aluminum, titanium or the like), a composite, a ceramic (e.g., a carbide, a nitride, a boronitride, or the like), or some other material. The plastic components of the assembly are preferably injection molded using conventional techniques and processing conditions. Alternatively, they may be prepared in another suitable manner, such as by compression molding, thermoforming, blow molding or the like.

Either or both of the component materials or the adhesive may be suitably treated (uniformly or locally) as desired to improve corrosion resistance, oxidation resistance, thermal resistance, or another characteristic of the final product. For instance, they might be admixed, impregnated or coated with suitable additives for achieving a desired property. In some instances, bond strengths might be enhanced by further contacting the adhesive with a suitable primer.

The adhesive of the present invention is a structural adhesive and more preferably is a curable on demand material. Any adhesive that after cure can withstand the conditions of use of an engine (e.g., for an automotive vehicle) can be used. Preferably such adhesive does not decompose or delaminate at temperatures of up to about 138° C. (280 □F.), more preferably up to about 143° C. (290 □F.), even more preferably up to about 160° C. (320 □F.) and most preferably up to about 191° C. (375 □F.).

Furthermore, the adhesive is able to withstand exposure to hydrocarbon materials, calcium chloride, brake fluid, glycol coolants, windshield washer solvents and the like, at the above-mentioned temperatures and the pressures to which the internal combustion engine reaches internally. In an optional embodiment, the adhesive is able to bond to other engine components, which may be metallic, ceramic, composite, plastic, or the like. The adhesive used may be curable via a variety of known mechanisms including heat cure, infrared cure, ultraviolet cure, chemical cure, radio frequency cure, solvent loss and moisture cure.

In another embodiment the adhesive is a cure-on-demand adhesive which requires a separate operation to cause the adhesive to begin to cure. In one embodiment this is achieved by using an encapsulated curing agent which is ruptured during assembly. In another embodiment this is achieved by removing a protective coating to expose the adhesive to ambient conditions. Cure can be initiated by exposing the adhesive to heat, infrared or ultraviolet light sources, or to shearing forces and the like.

While other adhesive families are contemplated as well (e.g., urethanes, acrylics, silanes, or the like), preferably the adhesive is a high temperature epoxy resin, a polyimide, a hybrid polyimide/epoxy resin adhesive or an epoxy novolac/nitrile rubber adhesive. Preferred adhesives are the high temperature epoxy resin adhesives. High temperature epoxy resin adhesive means an adhesive wherein the primary component is an epoxy resin which when cured can withstand exposure to the temperatures mentioned above without decomposing or delaminating from the substrate.

In a particularly preferred embodiment, the adhesive is a mineral filled catalyzed adhesive that includes one or more regular or modified epoxy components, a suitable curing agent and a suitable thixotropic agent for maintaining a room temperature Brookfield viscosity (in uncured state) on the order of about 500 cps.

It should be recognized that the use of the term adhesive herein is not intended to foreclose primers or other bonding agents from the scope of the present invention.

The present invention offers considerable design flexibility. Though mating surfaces can be planar, they need not be. In a preferred embodiment, either or both of the mating surfaces is generally non planar (e.g., contoured, stepped, corrugated, or the like). The employment of molded plastic components also enables the formation of intricately shaped structures. In this regard, the conductor assembly can have molded or otherwise fabricated in or on one of its surfaces one or more components such as brackets, connectors, cable guides, hose guides, harnesses, clips or the like. Further, conduits, ports or other like passages can be cored or machined into a molded component to enable integration of multiple components into the conductor assembly.

As will be appreciated by the skilled artisan, among the many advantages of the present invention are that assemblies can be made that are substantially free of folding tangs, a sealing gasket, mechanical fasteners or all of these. However, the scope of the present invention does not foreclose the use of folding tangs, gaskets or fasteners. Indeed, it is contemplated that a gasket might be made from (e.g., by die cutting a gasket) from the adhesive or incorporate as a component thereof (e.g. as an impregnant or coating), the adhesive of the present invention. The resulting structure seals much like a gasket would, but also exhibits the desirable mechanical characteristics of the structural adhesive.

Another advantage of the present invention is that, as shown in FIGS. 3, the adhesive can form an improved fluid tight seal between the hose 12 and the outlet 16 or between the outlet outlet 16 and the component 24. The adhesive may be placed continuously about the mating surface 14, 18, 20, 26 to allow the adhesive to form continuous seals about those surfaces 14, 18, 20, 26 such that fluid (e.g., water) may flow through the hose 12, outlet outlet 16 or both without an substantial leaking from any of the joints 34, 46, 48. Particularly advantageous in FIG. 3 is the channel 38 formed in the outlet outlet 16 for receiving the hose 12 in a manner that urges the adhesive to flow about relatively large portions of the mating surfaces 14, 18, 20, 26 to increase sealing area.

Though the present invention has been described in the context of automotive vehicle engine water conductor, the use of the invention is not intended to be limited thereby. Any apparatus employing a water conductor subject to operating conditions milder than or comparable to those experienced by an automotive vehicle engine may employ the present technology.

In preparation of the present assembly, the adhesive is applied by contacting the adhesive in a conventional fashion with one or more mating surfaces to form a continuous bead or film. The adhesive may be coated, extruded brushed or the like onto the surface. The adhesive can be applied immediately before joining components or it can be applied in remote location from the location where the components are bonded together, or the engine. The preferred cure-on-demand adhesive is exposed to conditions such that it will cure and thereby bond the components together and form a seal between them. Such conditions can be applied prior to or after bringing components together for joining. It is well within the average level of skill in the art to determine which operation may be used to cure the adhesive and when it should be performed. In one embodiment the operation may be an operation that is inherent in the assembly or operation of an automotive vehicle.

In another embodiment the assembly may include an outer shell and an inner shell adapted such that the inner shall is located within the outer shell and there is an insulating gap between the two. The gap can be filled with a fluid, or a solid material, such as elastomeric material or foam material. In another embodiment the conductor assembly may have associated with one of its surfaces a sound attenuating material or an insulator such as an elastomer or foam.

In another embodiment the assembly of the invention can include a coating or film on the exterior or interior which functions to improve the barrier properties of the conductor to hydrocarbons. Such a coating of film can reduce the fugitive hydrocarbon emission from an automotive vehicle. Any coating or film which prevents the transmission of hydrocarbons through the assembly may be used. A preferred coating is a carbon-silica based plasma deposited coating as described in U.S. Pat. No. 5,298,587; U.S. Pat. No. 5,320,875; U.S. Pat. No. 5,433,786 and U.S. Pat. No. 5,494,712 incorporated herein by reference.

Other surface treatments might also be employed such as plasma surface treatment pursuant to art disclosed teachings as found in U.S. Pat. No. 5,837,958, incorporated herein by reference.

The assembly of the present invention is capable of withstanding a temperature of about 163° C. (about 325° F.) for at least about 2500, and more preferably about 3000 hours and about 177° C. (about 350° F.)for at least about 75 and more preferably about 100 hours. The assembly exhibits substantially no detectable degradation in the presence of automotive vehicle fluids, such as brake fluid, windshield washer fluid, power steering fluid, engine coolant (standard and lifetime), engine oil (standard, synthetic and sour), gasoline, diesel fuel, ethanol, methanol, starter fluids or the like. The assembly also exhibits no detectable degradation due to exposure to environmentally encountered compounds such as calcium chloride, sodium chloride, exhaust gas (e.g. type) or the like. In a particularly preferred embodiment, the resulting tensile strength of the adhesive of the joint in the assembly is at least about 4000 psi (28 MPa), more preferably at least about 6500 psi (45 MPa), and still more preferably at least about 9000 psi (62 MPa). Further preferably the strength of the joint is greater than the strength of at least one, and preferably more than one, of the individual molded components.

Further preferably the strength of the joint is greater than the strength of at least one, and preferably more than one, of the individual molded components.

The technology of the present conductor assembly can be employed in combination with other adhesively bonded engine components, such as described in commonly owned co-pending application Ser. No. 09/766,792 (“Adhesively Bonded Valve Cover Cylinder Head Assembly”), (“Adhesively Bonded Oil Pan Assembly”) (filed contemporaneously herewith) hereby incorporated by reference.

It should be understood that the invention is not limited to the exact embodiment or construction, which has been illustrated and described but that various changes may be made without departing from the spirit and scope of the invention.

What is claimed is:

1. A water conductor assembly, comprising:
a) a hose having an associated first mating surface;
b) an outlet having an associated second mating surface; and
c) an adhesive in contact with said first mating surface and said second mating surface for joining said first component and said second component to define a water conductor assembly, wherein the resulting joint has a strength greater than the strength of said second molded plastic component.

2. The assembly of claim 1, wherein said first mating surface and said second mating surface are generally nonplanar.

3. The assembly of claim 1, wherein said second component is a blend of a polyamide and a syndiotactic polystyrene and said first component is an elastomer.

4. The assembly of claim 1, wherein each of said first component is an injection molded filled plastic blend of nylon 6,6 and syndiotactic polystyrene.

5. The assembly of claim 1, wherein said joint is substantially free of a sealing gasket.

6. The assembly of claim 1, wherein said joint is substantially free of mechanical fasteners.

7. The assembly of claim 1, wherein a primer contacts said adhesive.

8. The assembly of claim 1, wherein substantially the entirety of the first and second mating surfaces in contact with said adhesive is capable of bonding thereto.

9. An automotive vehicle conductor assembly, comprising:
a) an elastomeric hose having an associated first mating surface;
b) a molded thermoplastic annular outlet having an associated second mating surface and third mating surface;
c) a cast block having a fourth associated mating surface;
d) a first epoxy adhesive in contact with said first mating surface and said second mating surface for joining said hose to said outlet to at least partially define an automotive vehicle water conductor; and
e) a second epoxy adhesive in contact with said third mating surface and said fourth mating surface for joining said outlet and said cast block thereby further defining said water conductor.

10. The assembly of claim 9, wherein said third mating surface and said fourth mating surface are generally nonplanar.

11. The assembly of claim 9, wherein said outlet is a blend of polyamides and syndiotactic polystyrenes and said hose is an elastomer.

12. The assembly of claim 9, wherein said outlet injection molded filled plastic blend of nylon and syndiotactic polystyrene.

13. The assembly of claim 9, wherein said water conductor is substantially free of a sealing gasket.

14. The assembly of claim 9, wherein said water conductor is substantially free of mechanical fasteners.

15. The assembly of claim 9, wherein said outlet includes a channel for receiving said hose.

16. The assembly of claim 15, wherein said first adhesive is at least partially disposed in said channel.

17. The assembly of claim 9, wherein said outlet includes an adhesively attached gasket.
